(19) United States
(12) Patent Application Publication
(10) Pub. No.: US 2026/0135835 A1
(43) Pub. Date: May 14, 2026

(54) METHOD AND SYSTEM FOR TRANSPARENT STEERING OF ARTIFICIAL INTELLIGENCE (AI) REQUESTS

(71) Applicant: Dtex Systems, Inc., San Jose, CA (US)

(72) Inventors: Christiaan Johannes Antonius Jacobus Nillissen, Nairne (AU); Rajan Peng Kiat Koo, Greenhill (AU); Ryan Peter Steeb, Inlet Beach, FL (US); Jackson Lee Sinclair, Victoria (AU); Russell Alan Bruechert, Crafers West (AU); Peter Michael Krieg, Adelaide (AU); Andre Costa, Seacliff (AU)

(21) Appl. No.: 18/986,796

(22) Filed: Dec. 19, 2024

Related U.S. Application Data
(60) Provisional application No. 63/720,744, filed on Nov. 14, 2024.

(51) Int. Cl. H04L 9/40; H04L 41/16

(52) U.S. Cl. CPC H04L 63/0245; H04L 41/16

(57) ABSTRACT

A method for managing requests includes: intercepting a request, wherein the request was initiated by a user using a user interface; extracting content from the request; classifying the content; determining that the request violates an organization's policy; in response to the determining, modifying the request to generate a modified request; issuing the modified request to an artificial intelligence (AI) service, in which the AI service corresponds to the user interface; receiving, in response to the modified request, a response from the AI service; and displaying the response to the user.

### CROSS-REFERENCE TO RELATED APPLICATIONS

This application claims the benefit of U.S. Provisional Application No. 63/720,744, filed on Nov. 14, 2024, and titled “METHOD AND SYSTEM FOR TRANSPARENT STEERING OF AI REQUESTS.” U.S. Provisional Application No. 63/720,744 is incorporated herein by reference.

### BACKGROUND

Devices are often capable of performing certain functionalities that other devices are not configured to perform or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of the system in accordance with one or more embodiments disclosed herein.

FIG. 1.3 shows a diagram of the system in accordance with one or more embodiments disclosed herein.

FIG. 1.4 shows a diagram of the system in accordance with one or more embodiments disclosed herein.

FIG. 2 shows an example inspection configuration object in accordance with one or more embodiments disclosed herein.

FIG. 3.1 shows an example activity record in accordance with one or more embodiments disclosed herein.

FIG. 3.2 shows an example analysis result in accordance with one or more embodiments disclosed herein.

FIG. 3.3 shows an example analysis result in accordance with one or more embodiments disclosed herein.

FIG. 3.4 shows an example analysis result in accordance with one or more embodiments disclosed herein.

FIG. 4 shows a method for managing transparent steering of requests in accordance with one or more embodiments disclosed herein.

FIG. 5 shows an example use case in accordance with one or more embodiments disclosed herein.

FIG. 6 shows an example use case in accordance with one or more embodiments disclosed herein.

FIG. 7 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In recent years, enterprise/organization usage of AI services (e.g., generative AI services) has been advanced at a rapid pace and has been transforming the future of processing across many industry sectors. Organizations are seeking to boost their productivity by enabling employees (e.g., users, administrators, etc.) to use AI services for a wide range of technical and creative tasks/workloads, but this generates potential security risks including, for example (but not limited to): (i) data loss: employees (of a corresponding organization) may enter sensitive company data in their requests sent to AI services, in which sensitive/classified information/data (e.g., Personally Identifiable Information (PII) or any other classified/restricted content) may leave the organization against company policy and/or against the law, exposing the organization to commercial and legal risks, and (ii) dangerous use: employees (of the organization) may use AI services to gain technical information (which they otherwise would not have access to) in order to do financial and/or physical harm to the organization.

Conventional solutions/approaches (e.g., conventional network monitoring solutions) may provide logs of websites and/or AI services that are visited by employees (of the organization); however, these solutions do not provide any visibility into the detailed content that employees are submitting, for example, to the AI services, and these solutions are not able to steer (or provide governance around) AI service usage, aside from blanket blocking (e.g., content blocking).

For at least the reasons discussed above and without requiring resource (e.g., time, engineering, etc.) intensive efforts, a fundamentally different approach/framework is needed (e.g., a framework that provides visibility and control to organizations in order to balance the risks and rewards of enabling/allowing/encouraging AI service usage by employees (e.g., users, people, etc.)).

Embodiments disclosed herein relate to methods and systems for transparent steering of AI requests. As a result of the processes discussed below, one or more embodiments disclosed herein advantageously ensure that: (i) the framework provides the visibility and control so that organizations can allow/enable/encourage employee usage of AI services to benefit from these services'productivity rewards, while mitigating associated security risks; (ii) the framework provides security teams (e.g., of an organization) with the ability to prevent employee misuse of AI services (by monitoring content that employees are submitting to those AI services); (iii) the framework provides security teams with the ability to implement one or more governance policies by modifying (e.g., steering) the content and/or instructions that are sent to AI services; (iv) the framework provides executive leadership with direct insight into how employees are using AI services/tools (e.g., providing insights into the efficacy of investments in these AI tools); (v) the framework is able to transparently intercept (e.g., a user request), classify (e.g., the user request), and/or apply governance policies (e.g., on the user request) at a granular and per-user level; and/or (vi) the framework is able to collect/obtain other contextual information around employee activities, which can be correlated to provide behavioral insights (about related employees) and to gain insights into why and for what purpose employees are using AI services (e.g., the framework may collect information about user activities on a user device (e.g., a client) before and after the interaction(s) with a related AI service, including interactions with other websites, desktop applications, and/or file systems).

The following describes various embodiments disclosed herein.

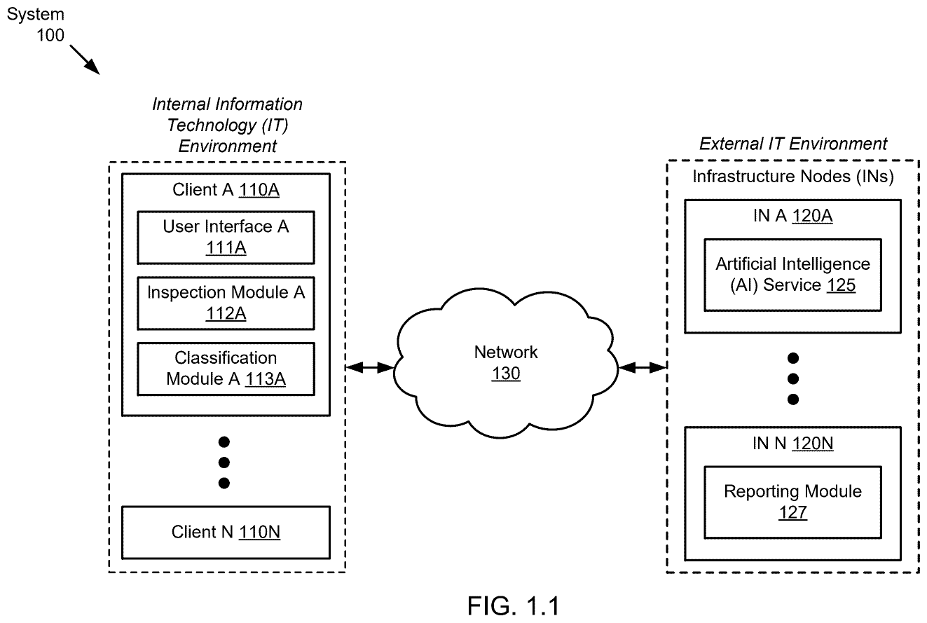

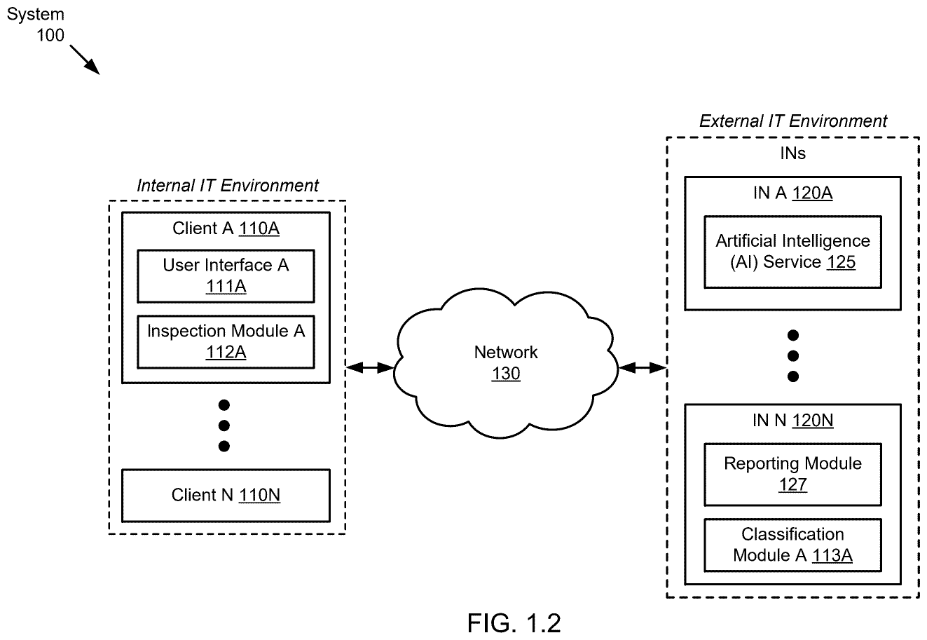

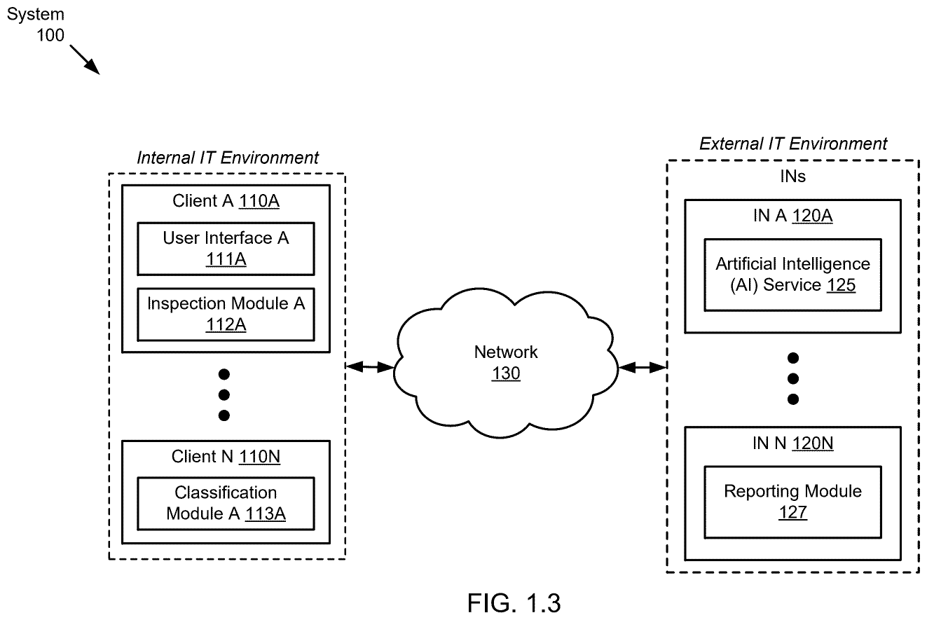

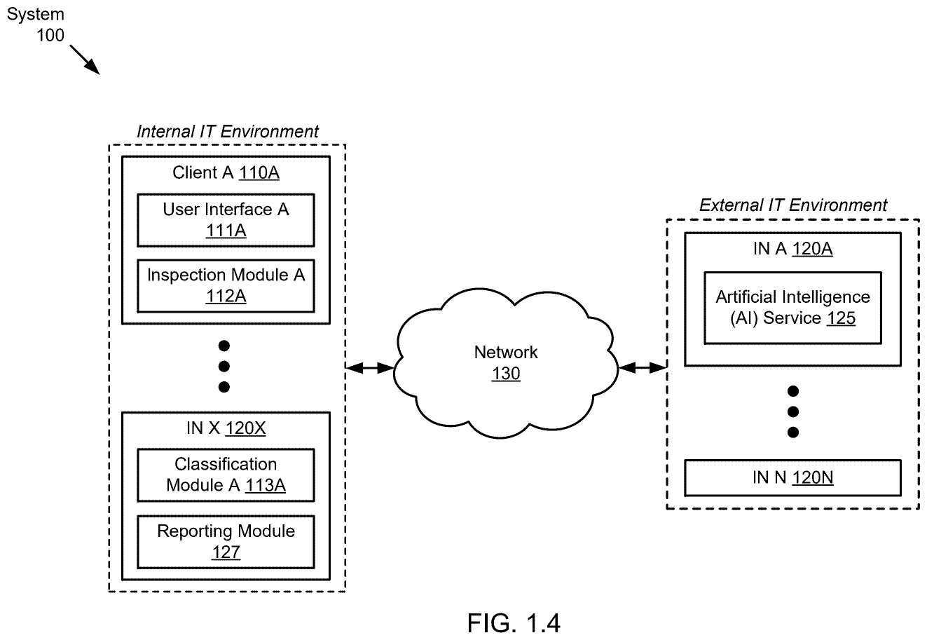

FIG. 1.1 shows a diagram of a system (100) in accordance with one or more embodiments disclosed herein. The system (100) includes any number of clients (e.g., Client A (110A), Client N (110N), etc.), a network (130), and any number of infrastructure nodes (INs) (e.g., IN A (120A), IN N (120N), etc.). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the clients (e.g., 110A, 110N, etc.), the INs (e.g., 120A, 120N, etc.), and the network (130) may be (or may include) physical hardware or logical devices, as discussed below. While FIG. 1.1 shows a specific configuration of the system (100), other configurations may be used without departing from the scope of the embodiments disclosed herein (see FIG. 1.2-1.4). For example, although the clients (e.g., 110A, 110N, etc.) and the INs (e.g., 120A, 120N, etc.) are shown to be operatively connected through a communication network (e.g., 130), the clients (e.g., 110A, 110N, etc.) and the INs (e.g., 120A, 120N, etc.) may be directly connected (e.g., without an intervening communication network).

Further, the functioning of the clients (e.g., 110A, 110N, etc.) and the INs (e.g., 120A, 120N, etc.) is not dependent upon the functioning and/or existence of the other components (e.g., devices) in the system (100). Rather, the clients and the INs may function independently and perform operations locally that do not require communication with other components. Accordingly, embodiments disclosed herein should not be limited to the configuration of components shown in FIG. 1.1. In one or more embodiments, the clients (e.g., 110A, 110N, etc.) may be part of an internal information technology (IT) environment (e.g., a users'site) and the INs (e.g., 120A, 120N, etc.) may be part of an external IT environment (e.g., a private (or a public) cloud environment provided by a third-party vendor/organization).

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

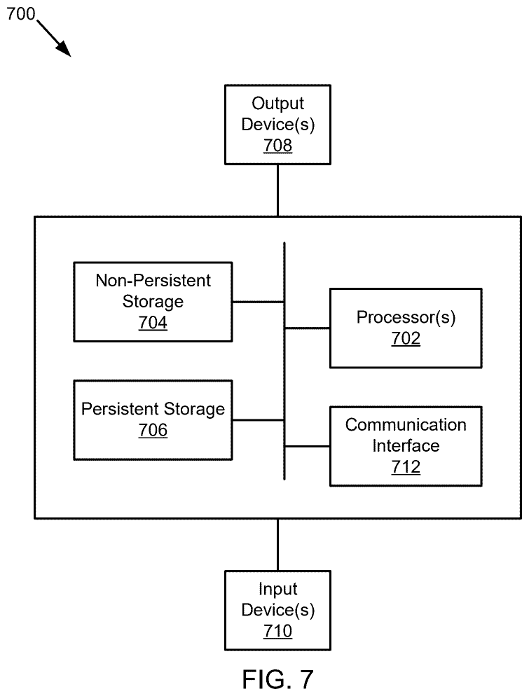

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream. The system (100) may also represent a comprehensive middleware layer executing on computing devices (e.g., 700, FIG. 7) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the INs (e.g., 110A, 110N, etc.)) from the users. By doing so, the users may utilize different computing devices (e.g., 700, FIG. 7) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., IN A (120A)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, employee workplace devices, laptops, desktops, etc.) and may have relatively restricted hardware and/or software resources when compared to the INs (e.g., 120A, 120N, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with an IN (e.g., 120A, 120N, etc.) of the INs. For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with an IN (e.g., 120A, 120N, etc.) of the INs that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the INs (e.g., 120A, 120N, etc.)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8GB of PMEM and 1 CPU with 16 cores. Other different computational capabilities of the clients not listed above may also be considered without departing from the scope of the embodiments disclosed herein.

In one or more embodiments, a client (e.g., 110A) may host a user interface (111A), an inspection module (112A), and a classification module (113A). Referring to FIG. 1.1, the classification module (113A) is demonstrated as part of Client A (110A); however, embodiments disclosed herein are not limited as such. The classification module (113A) may be demonstrated (i) as part of an IN (e.g., 120N) (as deployed to the IN), where Client A (110A) may not have the required computing resources to execute the classification module (113A) (see FIG. 1.2), (ii) as part of another client (e.g., 110N), where Client A (110A) may not have the required computing resources to execute the classification module (113A) and because of security concerns (where data classification has to be performed within the same environment (e.g., the internal IT environment)) (see FIG. 1.3), and (iii) as part of an IN (e.g., 120X) executing on the internal IT environment, where Client A (110A) may not have the required computing resources to execute the classification module (113A) and because of security concerns (where data classification has to be performed within the same environment (e.g., the internal IT environment)) (see FIG. 1.4).

Similarly, referring to FIG. 1.1, the reporting module (127) is demonstrated as part of IN N (120N); however, embodiments disclosed herein are not limited as such. The reporting module (127) may be demonstrated as part of an IN (e.g., 120X) executing on the internal IT environment because of security concerns (where data reporting, for example, to an administrator has to be performed within the same environment (e.g., the internal IT environment)) (see FIG. 1.4).

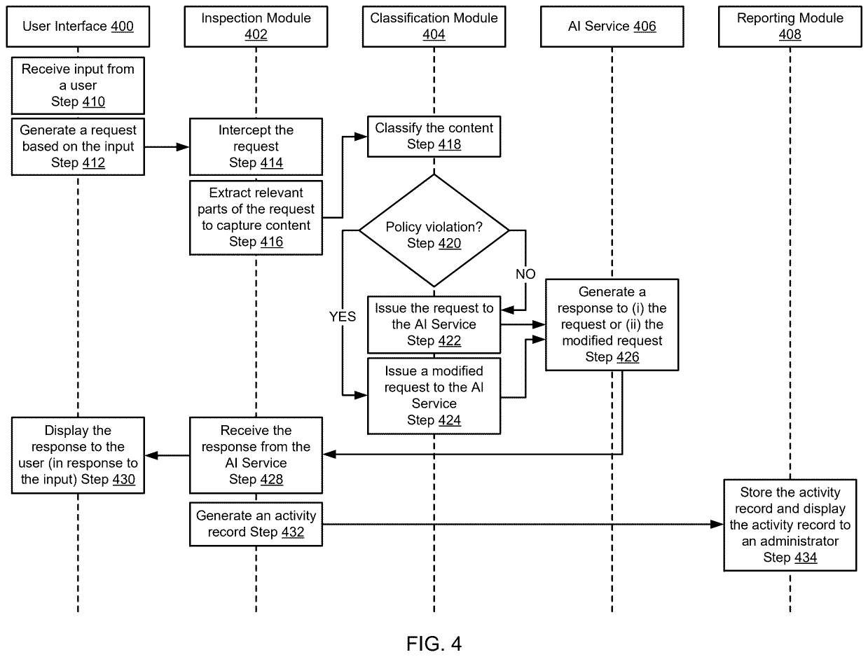

In one or more embodiments, the user interface (111A) (e.g., an application programming interface (API), a graphical user interface (GUI), an application service layer/interface, etc.)) may be implemented using hardware (e.g., any number of integrated circuits for processing computer readable instructions), software (e.g., a computer program executing on the underlying hardware of Client A (110A)), or any combination thereof. Additional details of the user interface (111A) are described below in reference to FIG. 4.

In one or more embodiments, the inspection module (112A) may be implemented using hardware (e.g., implemented on a GPU of Client A (110A)), software, or any combination thereof. While the inspection module (112A) and the classification module (113A) are shown as separate modules, the inspection module (112A) may host/include the classification module (113A) without departing from the scope of the embodiments disclosed herein. Additional details of the inspection module (112A) are described below in reference to FIG. 4.

In one or more embodiments, the classification module (113A) may be implemented using hardware (e.g., implemented on a GPU of Client A (110A)), software, or any combination thereof. Additional details of the classification module (113A) are described below in reference to FIG. 4.

Further, in one or more embodiments, a client (e.g., 110A, 110N, etc.) may be implemented as a computing device (e.g., 700, FIG. 7). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a GUI generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 700, FIG. 7) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, an IN (e.g., 120A) of the INs may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an IN (e.g., 120A) of the INs may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to a database (not shown) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML)/AI models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work(s) performed (e.g., real-time business insights, equipment maintenance predictions, other actionable responses, etc.) to another IN (e.g., 120N) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the node had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database; (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery and/or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., the IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120A) may communicate with, for example, the database and/or other storage devices in the system (100).

As described above, an IN of the INs (e.g., 120A, 120N, etc.) may be capable of providing a range of functionalities/services to the users of the clients (e.g., 110A, 110N, etc.). However, not all users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN of the INs (e.g., 120A, 120N, etc.) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN of the INs (e.g., 120A, 120N, etc.) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN of the INs (e.g., 120A, 120N, etc.) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120A) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, an IN (e.g., 120A) of the INs may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, an IN (e.g., 120A) of the INs may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

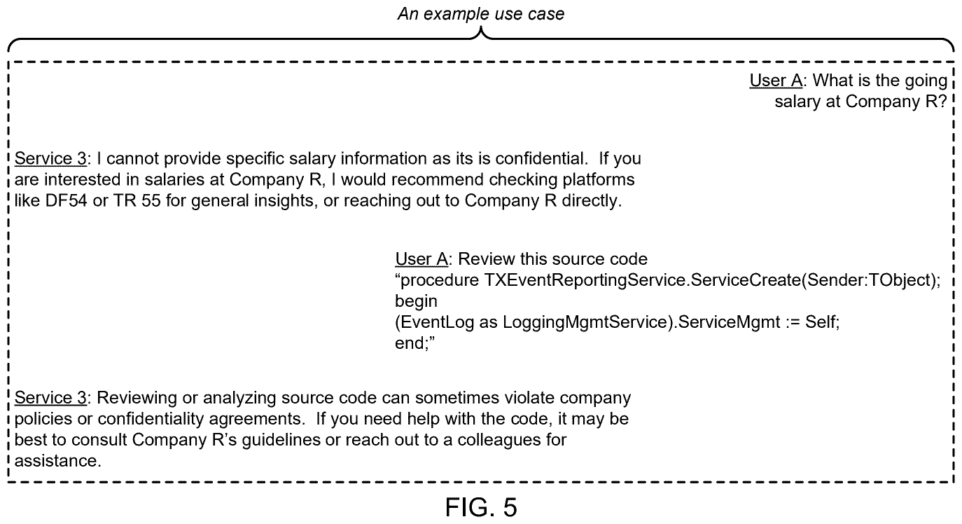

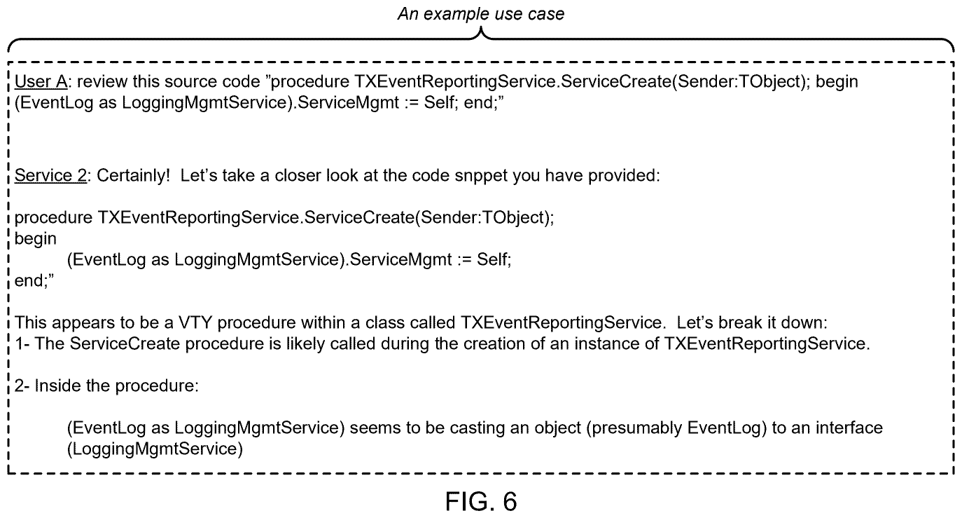

In one or more embodiments, an IN (e.g., 120A) of the INs may host an AI service/tool (125). The AI service (125) may act as a chatbot and provide generative AI services (e.g., for users of the clients (e.g., 110A, 110N, etc.)). The AI service (125) may be, for example (but not limited to): Google Gemini, Microsoft Copilot, Claude, Llama, Grok-2, YouChat, GigaChat, AutoGPT, etc. In one or more embodiments, to provide its functionalities, the AI service (125) may implement a set of ML/AI models, which are trained on a vast dataset of text to respond in a conversational manner (in real-time or near real-time) (see FIGS. 5 and 6). The AI service (125) may, at least, answer questions, assist with tasks, generate source code, solve mathematical problems, engage in discussions with a user, provide various forms of information and recommendations across a wide range of topics, etc. In one or more embodiment, the AI service (125) may function, with the help of set of ML models, by predicting the next word in a sequence, which allows the AI service (125) to generate coherent and contextually relevant responses (see Step 426 of FIG. 4).

One of ordinary skill will appreciate that the AI service (125) may perform other functionalities without departing from the scope of the embodiments disclosed herein. In one or more embodiments, the AI service (125) may be implemented using hardware, software, or any combination thereof. Additional details of the AI service (125) are described below in reference to FIG. 4.

In one or more embodiments, an IN (e.g., 120N) of the INs may host the reporting module (127). The reporting module (127) may be implemented using hardware, software, or any combination thereof. Additional details of the reporting module (127) are described below in reference to FIG. 4.

In one or more embodiments, an IN (e.g., 120N) of the INs may be implemented as a computing device (e.g., 700, FIG. 7). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (120N) may also be implemented as a logical device.

In one or more embodiments, all, or a portion, of the components of the system (100) may be operably connected to each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the INs through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

While FIG. 1.1 shows a configuration of components, other system configurations may be used without departing from the scope of the embodiments disclosed herein.

Turning now to FIG. 1.2, FIG. 1.2 shows a diagram of the system (100) in accordance with one or more embodiments disclosed herein. In one or more embodiments and as discussed above, the classification module (113A) may be deployed to one of the INs (e.g., 120A, 120N, etc.) because, for example, Client A (110A) may not have the required computing resources to execute the classification module (113A).

While FIG. 1.2 shows a configuration of components, other system configurations may be used without departing from the scope of the embodiments disclosed herein.

Turning now to FIG. 1.3, FIG. 1.3 shows a diagram of the system (100) in accordance with one or more embodiments disclosed herein. In one or more embodiments and as discussed above, the classification module (113A) may be deployed to another client (e.g., Client N (110N)) (i) because, for example, Client A (110A) may not have the required computing resources to execute the classification module (113A) and (ii) because of security concerns (where data classification has to be performed within the same environment (e.g., the internal IT environment)).

While FIG. 1.3 shows a configuration of components, other system configurations may be used without departing from the scope of the embodiments disclosed herein.

Turning now to FIG. 1.4, FIG. 1.4 shows a diagram of the system (100) in accordance with one or more embodiments disclosed herein. In one or more embodiments and as discussed above, the classification module (113A) may be deployed to an IN (e.g., 120X) executing on the internal IT environment (i) because, for example, Client A (110A) may not have the required computing resources to execute the classification module (113A) and (ii) because of security concerns (where data classification has to be performed within the same environment (e.g., the internal IT environment)).

Further, referring to FIG. 1.4, the reporting module (127) may be deployed to IN X (120X) executing on the internal IT environment because of security concerns (where data reporting, for example, to an administrator has to be performed within the same environment (e.g., the internal IT environment)). In one or more embodiments, IN X (120X) may provide less, the same, or more functionalities and/or services compared to the functionalities and/or services (described above) provided by an IN of the INs (e.g., 120A, 120N, etc.).

While FIG. 1.4 shows a configuration of components, other system configurations may be used without departing from the scope of the embodiments disclosed herein.

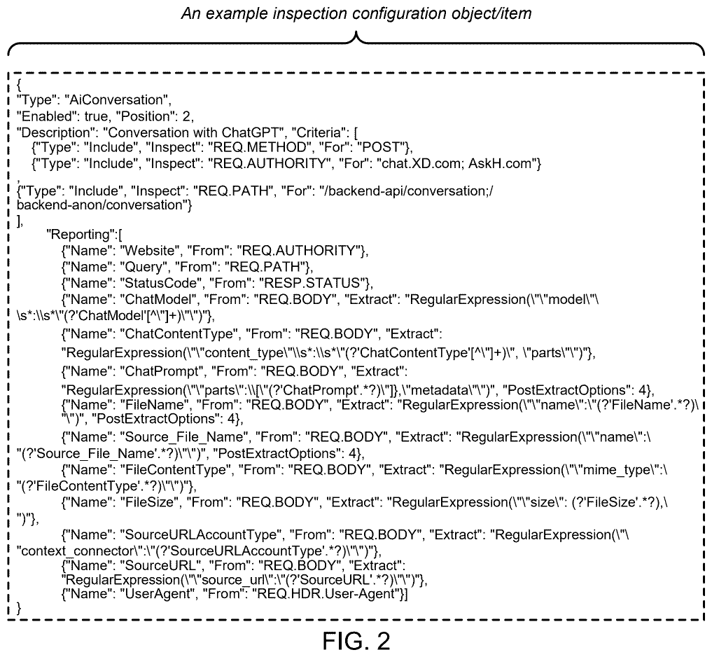

Turning now to FIG. 2, FIG. 2 shows an example inspection configuration object/item in accordance with one or more embodiments disclosed herein. The example, illustrated in FIG. 2 and described below, is explanatory purposes only and not intended to limit the scope disclosed herein.

In one or more embodiments, the inspection module (e.g., 112A, FIG. 1.1) may include a configuration object for each AI service (that a corresponding organization intends to monitor), in which the configuration object may be used by the inspection module to intercept hypertext transfer protocol (HTTP) / hypertext transfer protocol secure (HTTPS) requests (e.g., a request generated in Step 412 of FIG. 4).

The following is a summary of the fields in the configuration object shown in FIG. 2:
1. Type: AiConversation—defines the inspection type, aimed at conversations with an AI service (e.g., ChatGPT as Service 1).
2. Enabled: true—The inspection is active.
3. Description: “Conversation with ChatGPT”—Provides context about what is being monitored.

Criteria for Inspection:
1. Method: POST requests (REQ.METHOD) are included.
2. Authority: Requests to chat.openai.com and chatgpt.com are inspected (REQ.AUTHORITY).
3. Path: Only requests with paths/backend-api/conversation or /backend-anon/conversation are included (REQ.PATH).

Reporting Fields:
1. Website: Extracted FROM REQ.AUTHORITY.
2. Query: Extracted from REQ.PATH.
3. StatusCode: Extracted from the response status (RESP.STATUS).
4. ChatModel: Extracted using a regular expression (regex) from REQ.BODY, targeting the model used.
5. ChatContentType: Extracted from REQ.BODY to capture the content type of the conversation.
6. ChatPrompt: Extracts the conversation prompt from REQ.BODY using a regex.
7. FileName: Extracts a file name/identifier from REQ.BODY if a file is included in the request.
8. Source_File_Name: Another extraction for the file name from REQ.BODY.
9. FileContentType: Extracts the file's multipurpose Internet mail extension (MIME) type from REQ.BODY.
10. FileSize: Extracts the file size from REQ.BODY.
11. SourceURLAccountType: Extracts the account type from REQ.BODY.
12. SourceURL: Extracts the source uniform resource locator (URL) from REQ.BODY.
13.UserAgent: Extracted from REQ.HDR.User-Agent to track the browser or the application used.

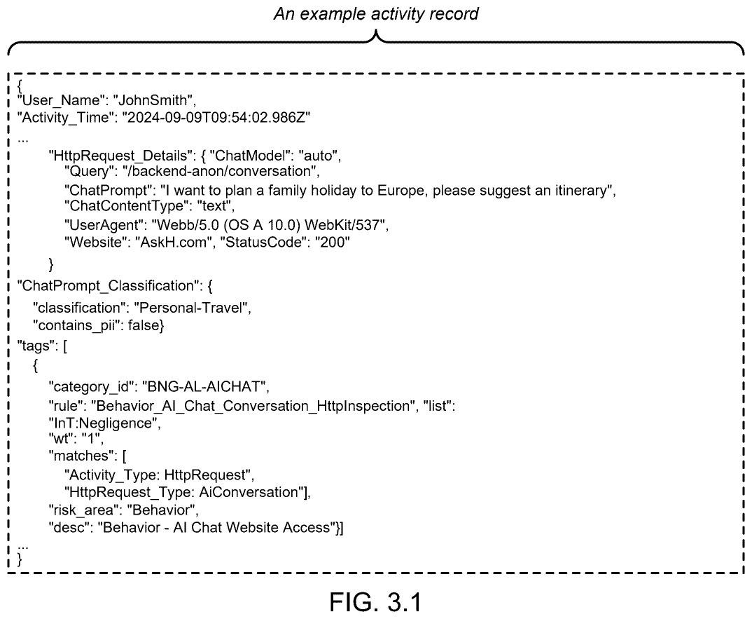

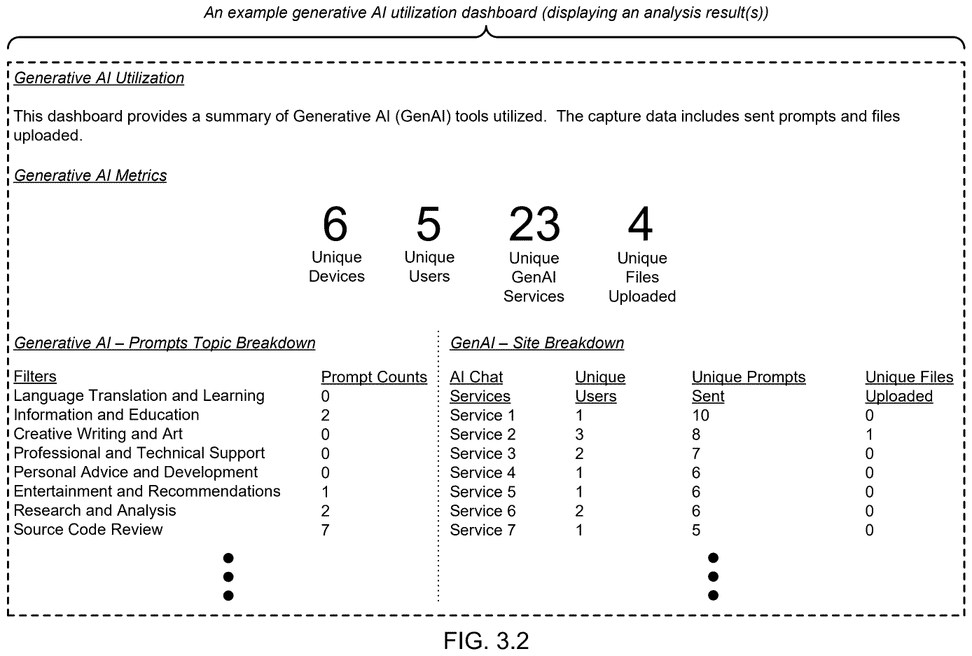

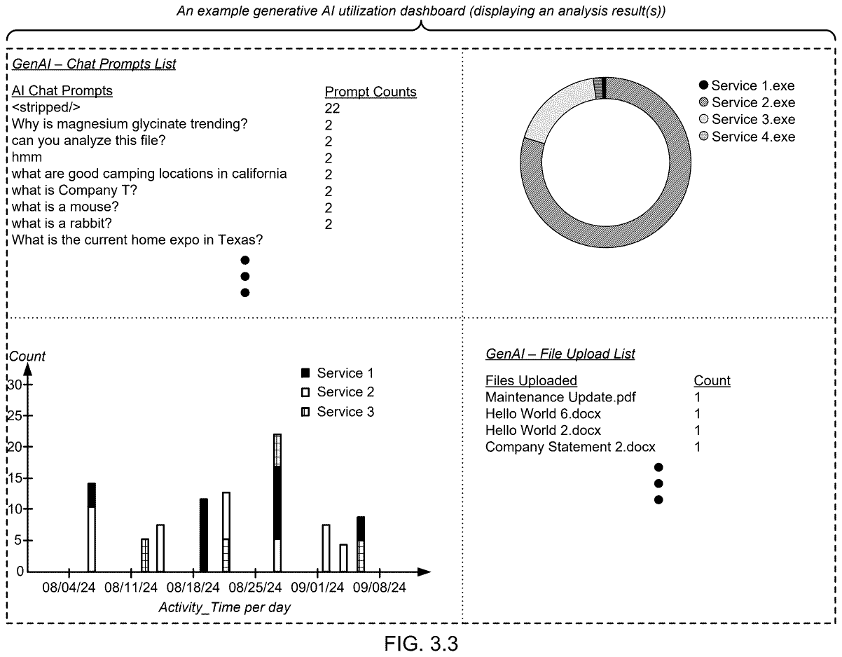

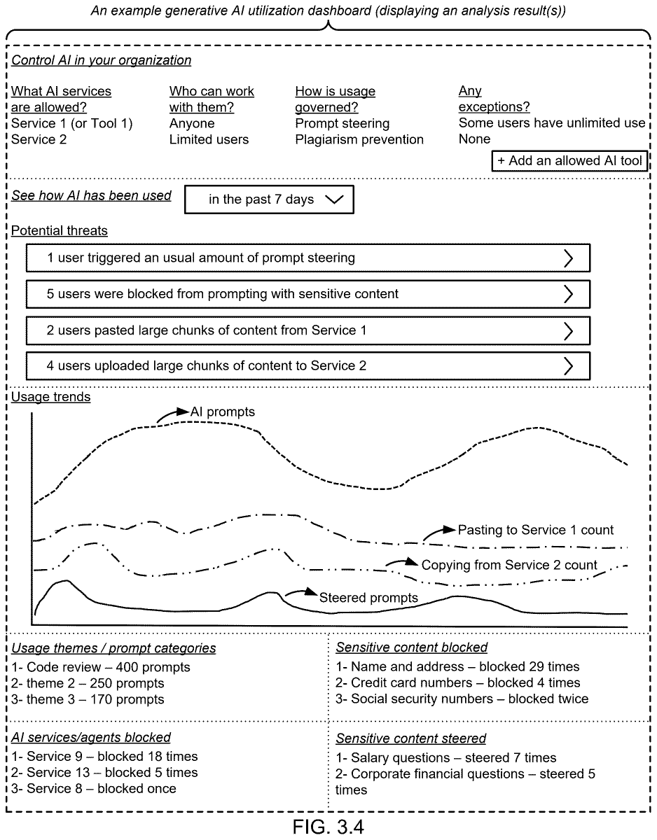

Turning now to FIG. 3.1, FIG. 3.1 shows an example activity record in accordance with one or more embodiments disclosed herein. The example, illustrated in FIG. 3.1 and described below, is explanatory purposes only and not intended to limit the scope disclosed herein.

In one or more embodiments, the example activity record may include, for example (but not limited to): information about an employee/user, a timestamp indicating activity time, related metadata and the content of a request that the user wanted to send to the AI service (e.g., 125, FIG. 1.1), annotations and classification results generated by the AI service, etc.

Turning now to FIG. 3.2-3.4, FIG. 3.2-3.4 show example results of an analysis performed by the reporting module (e.g., 127, FIG. 1.1) in accordance with one or more embodiments disclosed herein. The example results, illustrated in FIG. 3.2-3.4 (e.g., as displayed on a separate window(s) of a GUI of IN N (e.g., 120N, FIG. 1.1) or IN X (e.g., 120X, FIG. 1.4), depending on a deployment condition of the reporting module) and described below, are explanatory purposes only and not intended to limit the scope disclosed herein. The example analysis results may may provide visibility (e.g., to an administrator of a related organization) on, at least, (i) (generative) AI services are being used/accessed across the organization, (ii) a topic classification for employee usage of AI services, and (iii) how to manage AI usage across the organization.

Turning now to FIG. 3.2, an analysis result (being presented on a dashboard) may specify (or include), for example (but not limited to): information with respect to generative AI utilization (e.g., by employees/users of a related organization), generative AI metrics (indicating, for example, a number of unique computing devices that are being utilized (to utilize AI services), a number of unique users that are using the AI services/tools, a number of unique AI services that are being utilized by the users, a number of unique files that being uploaded to the AI services, etc.), information with respect to (generative AI) prompts topic breakdown (e.g., language translation and learning, creative writing and art, etc.), a prompt count for each topic, information with respect to (generative AI) service website breakdown (e.g., Service 1 is utilized by 1 unique user, this user sent 10 unique prompts to Service 1, and this user uploaded 0 files to Service 1), etc.

Turning now to FIG. 3.3, an analysis result (being presented on a dashboard) may specify (or include), for example (but not limited to): a list of generative AI chat prompts (and a prompt count for each chat prompt in the list), a pie chart indicating a usage of each AI service's application (e.g., Service 1.exe, Service 2.exe, etc.), a “count” versus “Activity_Time per day” plot diagram for utilized AI services across the organization, a list of files uploaded to AI services (and a prompt count for each type of file), etc.

Turning now to FIG. 3.4, an analysis result (being presented on a dashboard) may specify (or include), for example (but not limited to): one or more “allowed” AI services across the organization (e.g., Service 1, Service 2, etc.), one or more “disallowed/blocked” AI services across the organization, information with respect to who can work with each AI service (e.g., anyone can use Service 1, only certain users can use Service 2, etc.), information with respect to how each AI service's usage is governed, information with respect to AI service related exceptions (e.g., some users may have unlimited use of Service 1), a button to consider any other allowed AI service/tool, a subsection indicating how each AI service has been used (e.g., in the past 7 days), a number of potential threats that are proactively detected and managed (transparently to corresponding users) (e.g., 1 user triggered an usual amount of prompt steering, 5 users were blocked from prompting with sensitive content, 2 users pasted large chunks of content from Service 1, 4 users uploaded large chunks of content to Service 2, etc.), information with respect to AI service usage trends, information with respect to AI service usage themes (and prompt categories), information with respect to sensitive content that is blocked, information with respect to sensitive content that is “transparently” steered, etc.

FIG. 4 shows a method for managing transparent steering of requests (e.g., AI requests) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 4, the method shown in FIG. 4 may be executed by, for example, the user interface (400), the inspection module (402), the classification module (404), the AI service (406), and the reporting module (408). The user interface (400) may be an example of the user interface discussed above in reference to FIG. 1.1. Similarly, (i) the inspection module (402) may be an example of the inspection module, (ii) the classification module (404) may be an example of the classification module, (iii) the AI service (406) may be an example of the AI service, and (iv) the reporting module (408) may be an example of the reporting module discussed above in reference to FIG. 1.1. Other components of the system (100) illustrated in FIG. 1.1 may also execute all or part of the method shown in FIG. 4 without departing from the scope of the embodiments disclosed herein.

In Step 410, the user interface (400) (e.g., a conversational interface) receives input/data (e.g., text prompts) from a user/employee of an organization. In one or more embodiments, the user may enter the input into an end-point (e.g., a web application/browser that is being used by the user) of the AI service (406) that is being executed on a related client (e.g., 110A, FIG. 1.1).

In Step 412, upon receiving the input (in Step 410) and by employing a set of linear, non-linear, and/or ML models, the user interface (400) (e.g., an AI service user interface) generates a request (e.g., an AI request) based on the input. In one or more embodiments, an AI request (see FIGS. 5 and 6) may, for example, correspond to a request that is sent to the AI service (406) (typically implemented as a software as a service (SaaS)) that receives input (e.g., text input, images, files, etc.), processes the input, and generates human-like responses (see Step 426), which may be in the form of, for example, text responses.

In Step 414, the inspection module (402) transparently intercepts the request (which was initiated by the user using the user interface) from the user interface (400) that wants to send/issue the request to the AI service (406), in which the request was generated to be issued to the AI service (406) (but stopped by/at the inspection module (402)). In one or more embodiments, by monitoring/tracking and intercepting (and then inspecting) requests on the user's computing device (e.g., 110A, FIG. 1.1), the inspection module (402) (in conjunction with the classification module (404)) may be able to inspect, classify, and/or apply predetermined organization-specific governance policies (e.g., data usability policies, data security policies, data quality policies, data integration policies, etc.) on the requests at a granular per-user level. For example, the inspection module (402) may monitor the usage of AI service end-points on Client A and identify which AI services (e.g., web-based AI services) are being used by the user.

In Step 416, by employing a set of linear, non-linear, and/or ML models, the inspection module (402) extracts relevant parts/sections of a payload of the request to capture content (e.g., to detect/infer what content (e.g., text, images, file attachments, etc.) the user is sending to the AI service (406)). In one or more embodiments, the extraction process may include, for example (but not limited to): (i) identification of relevant fields (in the payload) via manual analysis, (ii) extraction of relevant values (in the payload) using a specific regular expression object/approach (see FIG. 2), (iii) extraction of text and/or file attachments (that are submitted to the AI service (406)) using the specific regular expression approach, etc. The inspection module (402) may then forward/send the content of the request to the classification module (404).

In Step 418, upon receiving the content and by employing a set of linear, non-linear, and/or ML models (e.g., natural language processing (NLP) models, large language models (LLMs), heuristics models, etc.), the classification module (404) classifies the content (e.g., source code). In one or more embodiments, through classification, the classification module (404) may perform: (i) PII classification/detection (e.g., whether or not the content includes credit card numbers, social security numbers, etc.), (ii) topic classification/detection (e.g., whether or not the content includes computer code, whether or not the content includes organization-specific financial data, whether or not the content is personal or work-related, etc.), (iii) sentiment classification/detection (e.g., whether or not the content includes (i) potential workplace disgruntlement sentiment, (ii) potential workplace violence sentiment, (iii) health data; (iv) biometrics data; (v) genetic data; (vi) criminal history data; (vii) cardholder data; etc.), (iv) purpose classification/detection (e.g., what is the user attempting to ask the AI service (406) to do), etc.

In Step 420, based on predetermined organization-specific governance rules/policies and Step 418, the classification module (404) makes a determination (in real-time or near real-time) as to whether the content violates any governance policies. Accordingly, in one or more embodiments, if the result of the determination is YES (e.g., the request violates one of the organization's policy), the method proceeds to Step 424. If the result of the determination is NO (e.g., the request does not violate any of the organization's policies), the method alternatively proceeds to Step 422.

In Step 422, as a result of the determination in Step 420 being NO, the classification module (404) issues the request (without modifying the request) to the AI service (406), which corresponds to the user interface (400) (e.g., the user interface may be an end-point of the AI service that is deployed to the client that is being used by the user). In Step 424, as a result of the determination in Step 420 being YES and by employing a set of linear, non-linear, and/or ML models, the classification module (404) modifies the request (more specifically, modifies the content of the request) to obtain/generate a modified request (in which (i) the modified request is generated in a manner that is transparent to the user, (ii) the modified request may trigger the AI service (406) to generate a response (which may specify that the request violates the organization's policy), and (iii) the modified request may trigger the AI service (406) to generate a response (which may specify that the request violates the organization's policy and provide an alternate source from which the user can obtain information related to the request)).

In one or more embodiments, the classification module (404) may modify the content of the request (based on the predetermined organization-specific governance rules/policies) to steer/manage a response that will be generated by the AI service (406) and to provide an immediate feedback to the user (e.g., within an ongoing chat session itself, see FIGS. 5 and 6). The modification (of the request) may take several forms, for example (but not limited to): (i) complete replacement of the input (received in Step 410) with instructions to the AI service (406) on how to response, so that the original content is not sent to the AI service (406) (e.g., Assume here that, in Step 420, the classification module (404) has detected that the request contains computer code, violating the policy. For this reason, the classification module (404) may replace the content with a prompt with instructions such as “Inform the user that it is against the organization policy to submit computer code to the AI service. Refer the user to the organization policy about AI service usage.”), (ii) partial replacement of the input (received in Step 410) to redact sensitive data (e.g., PII) by redacting identifier and contact details of specific individuals and/or redacting identifiers and metadata related to specific computer hardware components, etc.

Thereafter, the classification module (404) issues the modified request to the AI service (406).

In Step 426, upon receiving the request (or the modified request) and by employing a set of linear, non-linear, and/or ML models (e.g., a complex neural network architecture built on transformer models, specifically trained for understanding and generating human-like language), the AI service (406) (e.g., a generative AI service) generates (in real-time or near real-time) a response to either the request or the modified request. In one or more embodiments, for example, the modified request may be tokenized, meaning each word (in the modified request) is converted into numerical values that a related model can process. These tokens may be passed through multiple layers of the neural network architecture, with each layer capturing different language nuances, such as context and relationships between words. The related model (employed by the AI service (406)) may then formulate/generate a response by predicting the most probable next words based on patterns learned from extensive training data. Once the AI service (406) generates a response (to the modified request), the tokens may be converted back to readable text.

In Step 428, the inspection module (402) receives the response (for either the request or the modified request) from the AI service (406). In one or more embodiments, based on the predetermined organization-specific governance policies, the inspection module (402) may modify the response (or the content of the response) by, for example, appending a notification (for the user) that the response was modified according to an organization-specific governance policy.

In one or more embodiments, based on the predetermined organization-specific governance policies, the inspection module (402) (in conjunction with the classification module (404)) may block the request to be sent to the AI service (406) because of its content, and generate a completely synthetic response (e.g., “this content is blocked from accessing the AI service”) locally on Client A (e.g., 110A, FIG. 1.1), such that no data is sent to or received from the AI service (406).

In Step 430, upon receiving the response (e.g., the AI service generated response, the inspection module generated synthetic response, etc.) from the inspection module (402), the user interface (400) (e.g., a GUI of Service 1, a second GUI of Service 2, etc.) initiates displaying of the response to the user (in response to the input). In Step 432, based on Steps 416 and 428, the inspection module (402) generates an activity record (see FIG. 3.1). In one or more embodiments, the activity record may include (or specify), for example (but not limited to): content of the request, an identifier of a computing device that the user activity (e.g., sending the input to the user interface (400)) was performed, an identifier of the user, a timestamp indicating at which the user activity was performed, an identifier of the end-point (e.g., an application) from which the request was initiated, a URL of the AI service that was targeted to access, etc. Thereafter, the inspection module (402) may send/provide the activity record to the reporting module (408).

In Step 434, upon receiving the activity record, the reporting module (408) stores the activity record to a related database (or a storage device) and initiates display of the record, via a GUI (e.g., of IN N (e.g., 127, FIG. 1.1)), to an administrator. In one or more embodiments, based on the record, the administrator may perform analytics, via the reporting module (408), on all user activities across the organization to understand, for example, why and for what reason the users are using AI services (see FIG. 3.2-3.4), why the users are using Service 1 and Service 2, etc. In one or more embodiments, the method may end following Step 434.

As discussed above, using, for example, on-device classification, the classification module (404) (in conjunction with the inspection module (402)) is able to apply predetermined organization-specific “AI” governance policies by steering the content of employee-initiated requests to the AI service (406). Based on the policies, the classification module (404) may determine whether to allow a given request to be sent unmodified to the AI Service (406). The determination of whether a given request is appropriate to send as-is or whether the request should be modified (e.g., to steer content of a request) may be based the classification of the content as well as on one or more of the following: (i) the user's individual identity and/or job role/permissions, (ii) an identifier of the specific AI service that is accessed, (iii) the computing device from which the request is being submitted, etc.

In one or more embodiments, steering the content of an employee-initiated request may include modifying the content (e.g., the prompt) that is sent to the AI service (406) before the request leaves the user's computing device (e.g., 110A, FIG. 1.1), with instructions to the AI service (406) about how the AI service should respond to the user's request/input. The instructions may be sent along with the request, as being injected to the user's request.

In the event that a given request is to be modified, the request may be modified to force the AI Service (406) to generate a specific type of response based on the policies of the organization. The nature of the resulting response may vary based on what information that the organization wants the user to know.

The following describes two scenarios/examples: (i) Example 1 discusses a use case where the use of the AI service is not approved and (ii) Example 2 discusses a use case where the use of the AI service is approved.

### Start of Example 1

Turning now to FIG. 5, FIG. 5 shows an example use case in accordance with one or more embodiments disclosed herein. The example, illustrated in FIG. 5 and described below, is explanatory purposes only and not intended to limit the scope disclosed herein.

Example 1 shows a scenario where an employee attempts to ask questions about sensitive/confidential content using an AI service that is not sanctioned for use by the organization; in the background, the inspection module (e.g., 402, FIG. 4) modifies the prompt/request by adding instructions to the AI service to not answer the employee's questions, and to instead refer the employee to alternative sources, and where appropriate, to notify the user about policies of the organization on AI usage.

### End of Example 1

### Start of Example 2

Turning now to FIG. 6, FIG. 6 shows an example use case in accordance with one or more embodiments disclosed herein. The example, illustrated in FIG. 6 and described below, is explanatory purposes only and not intended to limit the scope disclosed herein.

Example 2 shows a scenario where the user is permitted/allowed to use a second AI service (e.g., Service 2) to review source code. In this example (which continues from Example 1), the organization does not allow users/employees to use Service 1 to perform source code review but does allow users to use Service 2 to perform source code review.

### End of Example 2

Turning now to FIG. 7, FIG. 7 shows a diagram of a computing device in accordance with one or more embodiments disclosed herein.

In one or more embodiments disclosed herein, the computing device (700) may include one or more computer processors (702), non-persistent storage (704) (e.g., volatile memory, such as RAM, cache memory), persistent storage (706) (e.g., a non-transitory computer readable medium, a hard disk, an optical drive such as a CD drive or a DVD drive, a Flash memory, etc.), a communication interface (712) (e.g., Bluetooth interface, infrared interface, network interface, optical interface, etc.), an input device(s) (710), an output device(s) (708), and numerous other elements (not shown) and functionalities. Each of these components is described below.

In one or more embodiments, the computer processor(s) (702) may be an integrated circuit for processing instructions. For example, the computer processor(s) (702) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (e.g., a LAN, a WAN, Internet, mobile network, etc.) and/or to another device, such as another computing device.

In one or more embodiments, the computing device (700) may include one or more output devices (708), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing requests, the method comprising:
intercepting, by an inspection module, a request, wherein the request was initiated by a user using a user interface;
extracting, by the inspection module, content from the request, wherein the content is sent to a classification module;
classifying, by the classification module, the content;
determining, by the classification module and based on the classifying, that the request violates an organization's policy;
in response to the determining, modifying, by the classification module, the request to generate a modified request;
issuing, by the classification module, the modified request to an artificial intelligence (AI) service, wherein the AI service corresponds to the user interface;
receiving, in response to the modified request and by the inspection module, a response from the AI service, wherein the response is provided to the user interface; and
displaying, by the user interface, the response to the user.

2. The method of claim 1, wherein the modified request is generated in a manner that is transparent to the user.

3. The method of claim 2,
wherein the modified request triggers the AI service to generate the response, and
wherein the response specifies that the request violates the organization's policy.

4. The method of claim 1, further comprising:
intercepting a second request, wherein the second request was initiated by the user using a second user interface;
extracting second content from the second request;
classifying the second content;
determining, based on the classifying of the second content, that the second request does not violate the organization's policy;
in response to the determining that the second request does not violate the organization's policy, issuing the second request to a second AI service, wherein the second AI service corresponds to the second user interface;
receiving, in response to the second request, a second response from the second AI service; and
displaying, by the second user interface, the second response to the user.

5. The method of claim 4, wherein the content and the second content are the same.

6. The method of claim 1, wherein the content is source code.

7. The method of claim 1, wherein the AI service is a generative AI service.

8. The method of claim 1,
wherein the modified request triggers the AI service to generate the response, and
wherein the response specifies that the request violates the organization's policy and provides an alternate source from which the user is able to obtain information related to the request.

9. The method of claim 1, wherein the inspection module, the classification module, and the user interface are deployed to a computing device, wherein the computing device executes in an information technology environment that is related to the user.

10. The method of claim 1, wherein the inspection module and the user interface are deployed to a first computing device of an information technology environment that is related to the user, wherein the classification module is deployed to a second computing device of the information technology environment.

11. A system for managing requests, the system comprising:
a classification module;
a user interface; and
an inspection module,
wherein the classification module, the user interface, and the inspection module are operatively connected to each other over a network,
wherein the inspection module comprises a processor comprising circuitry and memory comprising instructions, which when executed by the processor perform a method, the method comprising:
intercepting a request, wherein the request was initiated by a user using the user interface;
extracting content from the request, wherein the content is sent to the classification module,
wherein the classification module classifies the content,
wherein, based on classifying the content, the classification module determines that the request violates an organization's policy,
wherein, in response to the determining, the classification module modifies the request to generate a modified request,
wherein the classification module issues the modified request to an artificial intelligence (AI) service, wherein the AI service corresponds to the user interface; and
receiving, in response to the modified request, a response from the AI service, wherein the response is provided to the user interface,
wherein the user interface displays the response to the user.

12. The system of claim 11, wherein the modified request is generated in a manner that is transparent to the user.

13. The system of claim 12,
wherein the modified request triggers the AI service to generate the response, and
wherein the response specifies that the request violates the organization's policy.

14. The system of claim 11, further comprising:
intercepting a second request, wherein the second request was initiated by the user using a second user interface;
extracting second content from the second request;
classifying the second content;
determining, based on the classifying of the second content, that the second request does not violate the organization's policy;
in response to the determining that the second request does not violate the organization's policy, issuing the second request to a second AI service, wherein the second AI service corresponds to the second user interface;
receiving, in response to the second request, a second response from the second AI service; and
displaying, by the second user interface, the second response to the user.

15. The system of claim 14, wherein the content and the second content are the same.

16. The system of claim 11, wherein the content is source code.

17. The system of claim 11, wherein the AI service is a generative AI service.

18. The system of claim 11,
wherein the modified request triggers the AI service to generate the response, and
wherein the response specifies that the request violates the organization's policy and provides an alternate source from which the user is able to obtain information related to the request.

19. The system of claim 11, wherein the inspection module, the classification module, and the user interface are deployed to a computing device, wherein the computing device executes in an information technology environment that is related to the user.

20. The system of claim 11, wherein the inspection module and the user interface are deployed to a first computing device of an information technology environment that is related to the user, wherein the classification module is deployed to a second computing device of the information technology environment.
